(19) United States
(12) Patent Application Publication
(10) Pub. No.: US 2017/0364920 A1
(43) Pub. Date: Dec. 21, 2017

(54) SECURITY APPROACHES FOR VIRTUAL REALITY TRANSACTIONS

(71) Applicant: Vishal Anand, Lakhisarai (IN)

(72) Inventor: Vishal Anand, Lakhisarai (IN)

(21) Appl. No.: 15/184,759

(22) Filed: Jun. 16, 2016

(51) Int. Cl. G06Q 20/40; H04L 29/06

(52) U.S. Cl. CPC G06Q 20/40145; H04L 63/0861; H04L 63/0884

(57) ABSTRACT

One embodiment of the invention is directed to a computer-implemented method comprising, receiving an indication that an avatar of a user has initiated a transaction in a virtual reality environment. The method further comprises obtaining a first biometric sample from the user interacting with the virtual reality hardware. The method further comprises generating a partial biometric template based at least in part on the first biometric sample. The method further comprises providing the partial biometric template and personal authentication information for the avatar to an authentication computer where the personal authentication information and the partial biometric template are used to authenticate the avatar.

### CROSS-REFERENCES TO RELATED APPLICATIONS

None.

### BACKGROUND

Currently users can engage in e-commerce transactions purchasing and ordering a variety of goods from online merchants utilizing web browsers from the ease of their home. The access to a new commerce channel for merchants and consumers alike has resulted in a number of benefits including better service and increased revenue. Further, advancements in wearable devices enable users to interact with a virtual environment that serves as an interactive simulated environment accessed by users via an online interface. Users can play video games, interact socially with other users, or shop for items offered by merchants in the interactive simulated environment. However, security advancements and anti-fraud techniques have not kept up with transactions conducted via a virtual environment. Users conducting transactions may be subject to certain security vulnerabilities such as the sharing and proliferation of personal information and/or financial information such as credit card numbers or bank account information. Conventional security methods for transactions that occur in a virtual environment are subject to anti-encryption attacks or viruses. Conventional security methods also fail to account for whether a user associated with an avatar is actually logged in or driving the purchase in the virtual environment from the real world. These drawbacks may lead to abandonment of otherwise valid transactions and make users more susceptible to attacks by other entities seeking to obtain valuable personal information.

Embodiments of the invention address these and other problems, individually and collectively.

### BRIEF SUMMARY

Embodiments of the invention are directed to systems and methods related to authenticating transactions occurring in a virtual environment utilizing biometrics from a user in the real world and further information provided within the virtual environment.

In current solutions, secure authentication processes may be ignored or, if provided, with minimal oversight and with vulnerabilities to fraudsters. Users may provide bank account numbers, credit card numbers, or other personal information in the virtual environment which may be shared by unsecure systems or viruses present in transaction systems. Thus, if a user attempts to conduct a transaction for a real world item or to gain access to secure data/area, they may be susceptible to sharing personal and financial information. Further, information may be stored in a number of locations that are insecure. For example, each resource provider may store financial information associated with a user in their own databases that are further subject to attack by fraudsters.

Thus, there is a need for new and enhanced systems and methods of processing transactions that are more efficient and able to provide secure authentication-type services to all transactions in a virtual reality environment.

One embodiment of the invention is directed to a computer-implemented method comprising, receiving, by a processor associated with virtual reality hardware, an indication that an avatar of a user has initiated a transaction in a virtual reality environment, the virtual reality environment presented by the virtual reality hardware to the user. The computer-implemented method further comprises obtaining, by the processor, a first biometric sample from the user interacting with the virtual reality hardware. The computer-implemented method further comprises generating, by the processor, a partial biometric template based at least in part on the first biometric sample. The computer-implemented method further comprises providing, by the processor, the partial biometric template and personal authentication information for the avatar to an authentication computer, where the personal authentication information and the partial biometric template are used to authenticate the avatar

In some embodiments, the computer-implemented method further comprises obtaining, by the processor, a second biometric sample from the user via an associated computer device other than the virtual reality hardware. The computer-implemented method further comprises receiving an authentication response message, from the authentication computer, that is based in part on a machine learning algorithm comparing a risk score generated using the partial biometric template and the second biometric sample to a threshold.

In some embodiments, the authentication response message is provided to a resource provider associated with the transaction. In some embodiments, the computer-implemented method further comprises providing a transaction code to the avatar of the user to complete the transaction in response to providing the authentication response message to the resource provider.

In some embodiments, receiving the indication that the avatar of the user has initiated the transaction in the virtual reality environment includes presentation by the avatar of a unique identifier to a resource provider in the virtual reality environment. In some embodiments, the unique identifier includes a barcode or a representation of an access device in the virtual reality environment.

Embodiments of the invention are further directed to a server computer comprising a processor and memory. The memory can include instructions that, when executed with the processor, cause the server computer to perform operations for implementing any of the methods described herein. Embodiments of the invention are further directed to virtual reality hardware comprising a processor and memory. The memory can include instructions that, when executed with the processor, cause the virtual reality hardware to perform operations for implementing any of the methods described herein.

In some embodiments, the personal authentication information includes one or more of a password, an answer to a security question, or a unique alpha-numeric string. In some embodiments, the virtual reality hardware presents a prompt in the virtual reality environment to confirm the transaction.

In some embodiments, the transaction is associated with access to secure data or a secure area of a resource provider. In some embodiments, the virtual reality hardware includes instructions that when executed with the processor further cause the virtual reality hardware to generate a first incomplete set of eigenvalues based in part on the first biometric sample; salt the first incomplete set of eigenvalues using the personal authentication information; and provide the salted first incomplete set of eigenvalues to the authentication computer that is used to authenticate the avatar.

In some embodiments, generating the first incomplete set of eigenvalues includes using a particular number of characteristics of a set of eigenvalues based in part on a type of the transaction. In some embodiments, the personal authentication information is provided by the user prior to initiating the transaction in the virtual reality environment. In some embodiments, the first biometric sample is obtained from the user in response to receiving the indication that the avatar of the user has initiated the transaction in the virtual reality environment.

Embodiments of the invention are further directed to a computer-implemented method comprising receiving, by an authentication computer, a first biometric sample and personal authentication information associated with a user initiating a transaction in a virtual reality environment, the personal authentication information provided by an avatar of the user in the virtual reality environment. The computer-implemented method further comprises generating, by the authentication computer, a partial biometric template based at least in part on the first biometric sample. The computer-implemented method further comprises generating, by the authentication computer, a value based at least in part on the partial biometric template and the personal authentication information, the value representing a risk level associated with the transaction. The computer-implemented method further comprises authenticating, by the authentication computer, the transaction based at least in part on the value and a threshold associated with the transaction.

In some embodiments, the computer-implemented method further comprises providing an authentication response message to a resource provider computer associated with the transaction. In some embodiments, the computer-implemented method further comprises receiving, by the authentication computer, a second biometric sample of the user, the second biometric sample being different than the first biometric sample. The computer-implemented method further comprises generating, by the authentication computer, a first incomplete set of eigenvalues based in part on the first biometric sample, and a second incomplete set of eigenvalues based in part on the second biometric sample, wherein authenticating the transaction is further based at least in part on comparing a profile generated from the first incomplete set of eigenvalues and the second incomplete set of eigenvalues to an aggregate profile associated with the transaction.

In some embodiments, the value is generated further based in part on a machine learning algorithm using the first incomplete set of eigenvalues and the second incomplete set of eigenvalues. In some embodiments, the computer-implemented method further comprises providing a transaction code to the avatar of the user in the virtual reality environment enabling the user to complete the transaction. In some embodiments, the computer-implemented method further comprises presenting a prompt to the avatar of the user in the virtual reality environment to confirm the transaction.

These and other embodiments of the invention are described in further detail below.

### BRIEF DESCRIPTION OF THE DRAWINGS

FIG. 1 depicts an example system architecture capable of implementing at least some embodiments of the current disclosure;

FIG. 2 depicts a block diagram of a system and a process flow according to embodiments of the current disclosure;

FIG. 3 depicts exemplary virtual reality hardware according to embodiments of the current disclosure; and

FIG. 4 depicts a diagram illustrating an example technique for completing a transaction via virtual reality hardware according to embodiments of the current disclosure.

### DETAILED DESCRIPTION

Embodiments of the present invention may be directed at authenticating transactions occurring in a virtual reality environment using biometrics obtained from virtual reality hardware presenting the virtual reality environment and personal authentication information provided in the virtual reality environment to analyze risk associated with the transaction.

In some embodiments, a first biometric sample of the user obtained by the virtual reality hardware may be captured. A partial biometric template may be formed from the first biometric sample. This may be formed in any suitable manner. In one example, the partial biometric template may be formed by first forming a complete biometric template and then forming the partial biometric template from that complete biometric template. For example, a fingerprint of a user may be digitized to form a complete representation of the fingerprint. A specific subset of data from the complete digital representation of the fingerprint may then be obtained. The subset of data may include any suitable proportion of the complete digital representation (e.g., at least 40, 50, 60, 70, 80, or 90 percent). In another example, a partial biometric template may be formed directly from the first biometric sample. For example, instead of scanning an entire fingerprint, only certain portions of a user's finger may be scanned and converted into a digital representation.

In some embodiments, the partial biometric template may be formed using a first set of incomplete eigenvalues. The first set of incomplete eigenvalues may be generated utilizing the first biometric sample. Thereafter, a user may provide personal authentication information (e.g., a password) within the virtual reality environment which may be utilized to salt the first set of incomplete eigenvalues before they are provided to an authentication service. For example, the first set of incomplete eigenvalues may be morphed or transformed such as by multiplying by some factor or a matrix. The authentication service may be able to reconstruct the partial data from morphed data by division by the same factor or multiplication of the inverse of the same matrix which was multiplied and hence determine whether to authenticate the transaction. The morphing might also include introducing a random change of the values of the eigenvectors and corresponding eigenvalues. In some embodiments, an encryption and decryption may occur between the virtual reality hardware and authentication service computers to provide further security benefits. A second, different, biometric sample may be obtained from the user to generate a second incomplete set of eigenvalues before which is then also provided to the authentication service. The authentication service may utilize risk profiles compiled from previous comparisons of incomplete sets of eigenvalues from a plurality of transactions to identify the risk of a current transaction before authenticating the transaction.

In some embodiments, this process may be initiated by a user conducting a transaction in a virtual reality environment for an item provided in the real world. In some embodiments, the process may be initiated by a user seeking to gain access to secure data or a secure area that is stored or located in the virtual reality environment or the real world. In both of these examples, the virtual reality environment can be used as an intermediary between two entities conducting a transaction in the real world.

Embodiments of the present disclosure provide several advantages. For example, a user can conduct a transaction for a real world or virtual item without leaving the virtual world in a secure manner that reduces the amount and proliferation of sensitive information. As the user in not required to provide payment information such as bank account numbers, location or building access device, or credit or debit card numbers, to complete a transaction initiated in the virtual world, security benefits are gained as the likelihood that a fraudster can visually or through other means obtain sensitive information is greatly reduced. A user can experience greater convenience when attempting to conduct a transaction in the virtual world as the user is not required to leave the virtual world to complete the transaction. Instead, biometric samples of the user are obtained from the virtual reality hardware without requiring further input from the user. Existing payment processing networks can be leveraged without a large infrastructure overhaul as databases and software applications can be provisioned to aid in authenticating a virtual reality transaction utilizing biometric samples and other data provided about or by the user. As such, implementation of the invention described herein may advantageously include advantages for the use of networking, software, and hardware capabilities of existing payment processing networks and virtual reality hardware. They can be leveraged without purchasing additional infrastructure capabilities for in-store point of sale systems or e-commerce websites. Additionally, in some embodiments partial biometric templates are generated from a biometric sample and provided to the authentication computer or authentication. As such, any data that is captured during transmission includes only partial data that will make hacking or fraud activity more difficult for fraudsters.

Embodiments of the present invention may be used in transaction processing systems or may use data generated during transaction processing through a transaction processing system. Such embodiments may involve transactions between users and resource providers. Further, embodiments of the invention, as discussed herein, may be described as pertaining to financial transactions and payment systems. However, embodiments of the invention can also be used in other systems. For example, a transaction may be authorized for secure access of data or to a secure area.

Prior to discussing embodiments of the invention, descriptions of some terms may be helpful in understanding embodiments of the invention.

A “computer device” may comprise any suitable electronic device that may be operated by a user, which may also provide remote communication capabilities to a network. A “portable communication device” may be an example of a “computer device.” Examples of remote communication capabilities include using a mobile phone (wireless) network, wireless data network (e.g. 3G, 4G or similar networks), Wi-Fi, Wi-Max, or any other communication medium that may provide access to a network such as the Internet or a private network. Examples of computer devices include mobile phones (e.g. cellular phones), PDAs, tablet computers, net books, laptop computers, personal music players, hand-held specialized readers, etc. Further examples of computer devices include wearable devices, such as smart watches, fitness bands, ankle bracelets, rings, earrings, etc., as well as automobiles with remote communication capabilities. In some embodiments, a computer device can function as a payment device (e.g., a computer device can store and be able to transmit payment credentials for a transaction).

“Virtual reality hardware” may comprise any suitable electronic device that may be operated by a user, which may also provide presentation of an augmented reality or virtual reality. The virtual reality hardware may also provide remote communication capabilities to a network. Examples of virtual reality hardware include headsets, partial headsets, wearable devices, hand-held devices, lens equipment, or any suitable hardware that is capable of presenting a virtual reality and/or augmented reality to a user and is responsive to touch and haptic input.

“Virtual reality environment” may include a presentation via virtual reality hardware that incorporates any or all senses of a user to create a virtual world which may be a model of a real world or an artificial world. The virtual reality environment may include a computer-generated simulation of a three-dimensional image or environment that can be interacted with in a seemingly real way by a user utilizing virtual reality hardware. As used herein, the virtual reality environment may also include an augmented reality that superimposes a computer-generated image on a user's view of the real world and providing a composite view.

An “avatar of a user” includes a computer generated representation of the user interacting with the virtual reality hardware within the virtual reality environment. The avatar of the user may mimic movements and/or gestures that the user is making in the real or physical world that are relayed by the sensors associated with the virtual reality hardware.

A “biometric sample” includes data that can be used to uniquely identify an individual based upon one or more intrinsic physical or behavioral traits. For example, a biometric sample may include retinal scan and tracking data (i.e., eye movement and tracking where a user's eyes are focused). Further examples of biometric sample include digital photographic data (e.g., facial recognition data), digital sound data (e.g., voice recognition data), deoxyribonucleic acid (DNA) data, palm print data, hand geometry data, and iris recognition data.

A “biometric template” can be a digital reference of characteristics that have been extracted from one or more biometric samples. In some embodiments, the biometric template as used herein includes biometric samples for somewhat variable features associated with a user such as facial images and voice samples. Examples of variable features associated with a user include a fingerprint. Biometric templates may be used during an authentication process as described herein.

A “partial biometric template” includes a biometric template that is not a complete template of a biometric sample. A partial biometric template can include a portion of the data necessary to form a complete biometric template. The data forming the partial biometric template may include any suitable proportion (e.g., 30, 40, 60, 80, 90 percent, etc.) of a complete biometric template. The partial biometric template provides some correlation to a user, but not a complete correlation. Thus, if the partial biometric template is obtained by an unauthorized person in the virtual or real world, it cannot be used by that unauthorized person to conduct fraudulent transactions.

“Personal authentication information” may include any personal identifying information associated with a user that may be provided during an enrollment process with an authentication service. Examples of personal authentication information may include passwords, personal identification numbers (PIN) or challenge responses to questions asked of the user during the enrollment process. Further examples of personal authentication information may include information about the user themselves such as name, birth date, social security number, or contact information such as a home address, work address, and associated telephones (personal, home, etc.,).

“Eigenvalues” include a characteristic value associated with an eigenvector. In linear algebra, Geometrically, an eigenvector corresponding to a real, nonzero eigenvalue points in a direction that is stretched by the transformation and the eigenvalue is the factor by which it is stretched.

“Salting,” refers to a process by which data, sometimes random data, is used as an additional input to a one-way function that hashes other data, such as a password. As described herein, various information may be encoded by a salting process before being transmitted to an authentication service or other entity involved in the authentication process.

An “access credential” may be any data or portion of data used to gain access to a particular resource. In some embodiments, an access credential may include payment account information or a token associated with the payment account information, a cryptogram, a digital certificate, etc. A “transaction code” may be an example of an access credential.

An “access device” can include a device that allows for communication with a remote computer, and can include a device that enables a user to make a payment to a merchant in exchange for goods or services. An access device can include hardware, software, or a combination thereof. Examples of access devices include point-of-sale (POS) terminals, mobile phones, tablet computers, laptop or desktop computers, user device computers, user devices, etc.

An “application” may be computer code or other data stored on a computer readable medium (e.g., memory element or secure element) that may be executable by a processor to complete a task. Examples of an application include a biometric sample application, an authentication application, or a processing network application. An application may include a mobile application. An application may be designed to streamline the purchase and payment process or the process for accessing a secure area or secure data. An application may enable a user to initiate a transaction with a resource provider or merchant and authorize the transaction.

A “user” may include an individual. In some embodiments, a user may be associated with one or more personal accounts and/or mobile devices. The user may also be referred to as a cardholder, account holder, or consumer in some embodiments.

A “resource provider” may be an entity that can provide a resource such as goods, services, information, and/or access. Examples of resource providers include merchants, data providers, transit agencies, governmental entities, venue and dwelling operators, etc.

A “merchant” may typically be an entity that engages in transactions and can sell goods or services, or provide access to goods or services.

An “acquirer” may typically be a business entity (e.g., a commercial bank) that has a business relationship with a particular merchant or other entity. Some entities can perform both issuer and acquirer functions. Some embodiments may encompass such single entity issuer-acquirers. An acquirer may operate an acquirer computer, which can also be generically referred to as a “transport computer”.

An “authorizing entity” may be an entity that authorizes a request. Examples of an authorizing entity may be an issuer, a governmental agency, a document repository, an access administrator, etc.

An “issuer” may typically refer to a business entity (e.g., a bank) that maintains an account for a user. An issuer may also issue payment credentials stored on a user device, such as a cellular telephone, smart card, tablet, or laptop to the consumer.

An “authorization request message” may be an electronic message that requests authorization for a transaction. In some embodiments, it is sent to a transaction processing computer and/or an issuer of a payment card to request authorization for a transaction. An authorization request message according to some embodiments may comply with ISO 8583, which is a standard for systems that exchange electronic transaction information associated with a payment made by a user using a payment device or payment account. The authorization request message may include an issuer account identifier that may be associated with a payment device or payment account. An authorization request message may also comprise additional data elements corresponding to “identification information” including, by way of example only: a service code, a CVV (card verification value), a dCVV (dynamic card verification value), a PAN (primary account number or “account number”), a payment token, a user name, an expiration date, etc. An authorization request message may also comprise “transaction information,” such as any information associated with a current transaction, such as the transaction amount, merchant identifier, merchant location, acquirer bank identification number (BIN), card acceptor ID, information identifying items being purchased, etc., as well as any other information that may be utilized in determining whether to identify and/or authorize a transaction.

An “authorization response message” may be a message that responds to an authorization request. In some cases, it may be an electronic message reply to an authorization request message generated by an issuing financial institution or a transaction processing computer. The authorization response message may include, by way of example only, one or more of the following status indicators: Approval—transaction was approved; Decline—transaction was not approved; or Call Center—response pending more information, merchant must call the toll-free authorization phone number. The authorization response message may also include an authorization code, which may be a code that a credit card issuing bank returns in response to an authorization request message in an electronic message (either directly or through the transaction processing computer) to the merchant's access device (e.g. POS equipment) that indicates approval of the transaction. The code may serve as proof of authorization.

A “server computer” may include a powerful computer or cluster of computers. For example, the server computer can be a large mainframe, a minicomputer cluster, or a group of servers functioning as a unit. In one example, the server computer may be a database server coupled to a Web server. The server computer may comprise one or more computational apparatuses and may use any of a variety of computing structures, arrangements, and compilations for servicing the requests from one or more client computers.

A “payment processing network” (e.g., VisaNet™) may include data processing subsystems, networks, and operations used to support and deliver authorization services, exception file services, and clearing and settlement services. An exemplary payment processing network may include VisaNet™. Payment processing networks such as VisaNet™ are able to process credit card transactions, debit card transactions, and other types of commercial transactions. VisaNet™ in particular, includes a VIP system (Visa Integrated Payments System) which processes authorization requests and a Base II system which performs clearing and settlement services. A payment processing network may be referred to as a processing network computer.

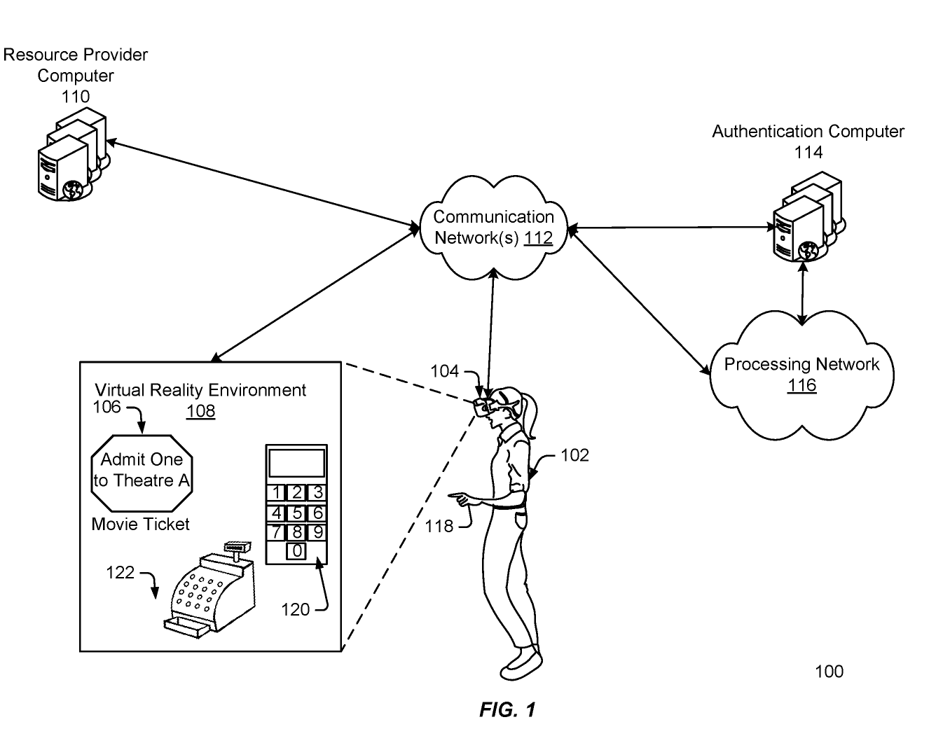

FIG. 1 depicts an example system architecture capable of implementing at least some embodiments of the current disclosure. Each of these systems and computers may be in operative communication with each other. For simplicity of illustration, a certain number of components are shown in FIG. 1. It is understood, however, that embodiments of the invention may include more than one of each component. In addition, some embodiments of the invention may include fewer than or greater than all of the components shown in FIG. 1. In addition, the components in FIG. 1 may communicate via any suitable communication medium (including the Internet), using any suitable communications protocol.

FIG. 1 includes a user 102 interacting with virtual reality hardware 104 to conduct a transaction for a movie ticket 106 that is presented in a virtual reality environment 108 to an avatar of the user 102. In embodiments, the virtual reality hardware 104 may present or provide the virtual reality environment 108 to the user 102 as they interact with the virtual reality hardware 104. In embodiments, the user 102 may interact in and with the virtual reality environment 108 to browse, search, and purchase items or services provided by a resource provider. FIG. 1 includes a resource provider computer 110 presenting or providing items and services to the virtual reality environment 108 for the user 102 to interact with via communication networks 112. In some embodiments, one or more resource provider computers 110 may provide assets or various attributes which help create the simulation or world that is presented in the virtual reality environment 108. In FIG. 1, the resource provider computer 110 may provide the asset or capability for the user 102 to access or purchase a movie ticket 106 to see a movie in the real world at Theatre A (not pictured).

FIG. 1 also includes an authentication computer 114 and a processing network 116 that can authenticate the transaction of user 102 for the movie ticket 106 as described herein. In some embodiments, the user 102 may initiate the transaction for the movie ticket 106 by directing or gesturing 118 their avatar within the virtual reality environment 108 to access the movie ticket 106. For example, the virtual reality hardware 104 may be capable of interpreting haptic input provided by the user via other computing devices associated with the user such as touch sensors or motion sensors. In some embodiments, the user 102 may gesture or instruct the avatar through various inputs to provide a unique identifier, such as a barcode, within the virtual reality environment 108 to a representation of an access point or point of sale device 122 associated with purchasing the movie ticket 106 to initiate a transaction. The representation of the access point or point of sale device 122 may be provided by the resource provider computer 110 for presentation and interaction within virtual reality environment 108. In embodiments, the virtual reality hardware 104 may obtain a biometric sample of the user 102 in response to receiving an indication that an avatar of the user 102 has initiated a transaction within the virtual reality environment 108. It should be noted that although FIG. 1 and other embodiments discuss a virtual reality transaction for real world equivalents, embodiments can also include a virtual reality transaction for virtual reality items such as other assets to enhance or interact with in the virtual reality environment.

In some embodiments, an avatar of the user 102 may be prompted to provide personal authentication information within the virtual reality environment in response to initiating the transaction for movie ticket 106. For example, FIG. 1 includes a representation of a keypad 120 which the user's 102 avatar can interact with to provide the personal authentication information. As described above, the user 102 may gesture 118 or provide other input that instructs the avatar within the virtual reality environment 108 to provide the personal authentication input via the keypad 120. In some embodiments, the virtual reality hardware 104 may be configured to generate a partial biometric template of the user 102 and transmit the partial biometric template and the personal authentication information to the authentication computer 114 for authenticating the transaction. The virtual reality hardware 104 may provide the partial biometric template and personal authentication information to the authentication computer 114 via the communication networks 112. In some embodiments, the partial biometric template may be salted using the personal authentication information before provision to the authentication computer 114.

In embodiments, the user may have previously engaged in an enrollment process with authentication computer 114 to enable authentication of transactions conducted within a virtual reality environment 108. The enrollment process may include the user providing one or more reference biometric samples which can be utilized to generate a plurality of reference biometric templates for use in the authentication process described herein. Other information may be provided during the enrollment process to the authentication computer 114 such as account information, credit card numbers, bank account numbers, digital wallet references, other suitable information such as personal authentication information, a shipping address, and contact information. Information about one or more computer devices (device information) or virtual reality hardware associated with a user may be obtained by the authentication computer 114 during the enrollment process such as device identifiers, network identifiers, and global positioning satellite information to determine a user's location.

In some embodiments, the authentication computer 114 may receive and process the partial biometric template and personal authentication information to authenticate the transaction. In embodiments, the authentication computer 114 may authenticate the transaction by decrypting the salted partial biometric template and comparing it to the biometric template associated with the user that was generated during the enrollment process. As described herein, the partial biometric template may be morphed or transformed before being provided to the authentication computer 114. Embodiments disclosed herein include morphing or transforming the partial biometric template utilizing the same salt (reverse morphing of the eigenvalues and eigenvectors) for comparison to the biometric template maintained by the authentication computer 114. In embodiments, the partial biometric template may be salted and encrypted, or just encrypted, and processed accordingly by the authentication computer 114. For example, the partial biometric template may be encrypted utilizing a private-public key shared by the virtual reality hardware 104 and the authentication computer 114. In another example, the partial biometric template may be salted by some factor and encrypted for multiple redundant security benefits. In some embodiments, the authentication computer 114 may determine or generate a risk value based on the similarity of the comparison between the partial biometric template and the reference biometric template. The risk value may be compared to a threshold for the transaction. For example, the authentication computer 114 may maintain a plurality of thresholds that correspond to different types of transactions (such as a particular threshold for transactions involving currency and a different threshold for transactions involving access to data). In some embodiments, the authentication computer 114 may utilize a machine learning algorithm to generate one or more transaction profiles that can be used to determine a risk value to compare to the threshold based on previously received partial biometric templates provided by a user. For example, the machine learning algorithm may be provided with a plurality of training data to utilize to generate the transaction profiles which can be compared to recently submitted partial biometric templates to determine a risk score. Other techniques such as template clustering can be used to determine a risk value associated with the pending transaction. In some embodiments, the machine learning algorithm may be trained with morphed, transformed, or salted eigenvector and corresponding eigenvalues thereby enabling subsequent submissions of similar data to be properly authenticated by the authentication service computers. In embodiments, a partial biometric template that was transformed via a salting process by a particular factor may be submitted to the authentication service which may in turn utilize a machine learning algorithm to properly compare the transformed data to transformed data corresponding to the user. In still some embodiments, the submitted transformed data may be transformed back to an original, un-transformed, state that maintains the partial nature of the biometric template for comparison and authentication of the user. The machine learning algorithm may utilize the submitted samples and maintained templates to generate a risk score that can be compared to a threshold value for determining whether to authenticate the transaction. Multiple variations of comparing the risk score to the threshold values may be suitable for determining authentication of a user for the transaction in the current disclosure. For example, a transaction may be determined to be authenticated if the risk score exceeds the threshold, exceeds the threshold by a certain amount, is within a certain range of the threshold, etc. Further, in some embodiments where one or more risk scores are generated from one or more biometric samples (a first biometric sample and a second biometric sample), the scores may be additively compared to the risk threshold, the transaction may be authenticated if the scores are within a certain range of the threshold, if at least a first percentage of the scores are within the range of the threshold, reject the authentication if at least a second percentage of the score exceed the threshold, or reject the authentication if none of the scores are within a certain range of the threshold. Any suitable combination of the above combinations may be utilized to determine whether to authenticate a transaction.

In some embodiments, where an incomplete set of eigenvalues is provided, the authentication computer 114 may utilize eigenvalue clustering to determine the authenticity of the individual and authenticate the transaction. In some embodiments, a biometric sample captured by the virtual reality hardware 104 or an associated computing device (not pictured) may be converted into eigenvectors and corresponding eigenvalues utilizing principal component analysis (PCA) or any suitable transformation/conversion statistical procedure resulting in principal components. In embodiments, software applications and/or algorithms associated with the virtual reality hardware 104 may calculate and determine a significance of the eigenvectors and eigenvalues for the biometric sample and rank them for contribution to a complete biometric sample. In embodiments, a certain portion of the resulting eigenvectors and their corresponding eigenvalues may be selected to form the partial biometric template. For example, a certain portion of top ranking eigenvectors/eigenvalues may be selected for forming the partial biometric template. In still another example, a randomized selection of a portion or portions that is less than the entire sample may be selected to form the partial biometric template. In embodiments, the authentication computer 114 may be configured to utilize various combinations and/or selections of the eigenvectors and corresponding eigenvalues of a partial biometric sample to determine whether to authenticate a transaction, such as by generating a risk score to compare to a risk threshold. In some embodiments, the computer device (not pictured) associated with user 102 may capture another and different biometric sample of the user for use in generating a second partial biometric template that can be utilized by authentication computer 114 to authenticate the user and the transaction. For example, the virtual reality hardware 104 may be utilized to obtain and capture a first biometric sample of the user 102 (such as a facial image) and generate a first partial biometric template and a mobile phone associated with the user 102 may capture a second biometric sample of the user 102 (such as a finger print) and generate a second partial biometric template. Both partial biometric templates can be transmitted to the authentication computer 114 via communication networks 112. In embodiments, the virtual reality hardware 104 may include multiple devices or pieces of hardware that are capable of obtaining and capturing one or more different biometric samples of a user 102 during the conducting of a transaction. As described above, the user 102 does not have to leave the virtual reality environment 108 to authenticate themselves as part of the transaction process but instead the hardware and software associated with presenting the virtual reality environment 108 captures and transmits the appropriate information to the authentication computer 114. Further, the capture and generation of the partial biometric templates can be performed in real time so that the user can complete the transaction in an efficient manner that does not require them to leave the virtual reality environment 108 and they can continue to browse and interact with said environment.

In some embodiments, the virtual reality hardware 104 may provide the partial biometric template and the personal authentication information to the authentication computer 114 as part of an authentication request message. In embodiments, the authentication computer 114, upon authenticating the transaction, may communicate the authentication result to the resource provider computer 110 and/or the processing network 116. The resource provider computer 110 or the processing network 116 may then generate an authorization request message which may request authorization for the desired transaction. The authorization request message may be received by the processing network 116 or an issuer computer in communication with the processing network 116. Either may determine that the user 102 has an appropriate amount of funds to complete the transaction that involves a monetary amount. In embodiments, the processing network 116 or an issuer computer in communication with the processing network 116 may generate and provide an authorization response message to the resource provider computer 110. For example, the resource provider computer 110 may receive the authorization response message from the processing network 116 and provide the user 102 or an account of the user 102 with the movie ticket 106 for use in the real world at Theatre A. The resource provider computer 110 may receive an authentication response message generated by the authentication computer 114 when the transaction involves access to secure data or a secure area within the virtual reality environment or other venues in the real world.

In some embodiments, the user 102 may be prompted via the virtual reality environment 108 to confirm the purchase. The authentication computer 114 and the processing network 116 may generate and provide a one-time user code or identifier that can be presented by the avatar of the user 102 in the virtual reality environment to complete the transaction. For example, the avatar of the user 102 may present a quick response (QR) code to a representation of a POS device in the virtual reality environment 108 to complete the transaction for the movie ticket 106.

The virtual reality hardware 104 may include a processor, memory, input/output devices, and a computer readable medium coupled to the processor. The computer readable medium may comprise code, executable by the processor for performing the functionality described herein. In some embodiments, the virtual reality hardware 104 may include applications (e.g., computer programs) stored in the memory and configured to retrieve, present, and send data across a communications network (e.g., the Internet).

The resource provider computer 110 may be comprised of various modules that may be embodied by computer code, residing on computer readable media. The resource provider computer 110 may include a processor and a computer readable medium coupled to the processor, the computer readable medium comprising code, executable by the processor for performing the functionality described herein. The resource provider computer 110 may be in any suitable form. Examples of the resource provider computer 110 may include a web server computer hosting a merchant virtual reality entity accessible by an avatar of the user 102. Additional examples of resource provider computers include any device capable of accessing the Internet, such as a personal computer, cellular or wireless phones, personal digital assistants (PDAs), tablet computers, and handheld specialized readers.

The processing network 116 may be a payment processing network computer, and may comprise a server computer. The server computer may include a processor and a computer readable medium coupled to the processor, the computer readable medium comprising code, executable by the processor. In some embodiments, the server computer may be coupled to a database and may include any hardware, software, other logic, or combination of the preceding for servicing the requests from one or more client computers.

The processing network 116 may include data processing subsystems, networks, and operations used to support and deliver authorization services, exception file services, and clearing and settlement services. An exemplary processing network 116 may include VisaNet™. Networks that include VisaNet™ are able to process credit card transactions, debit card transactions, and other types of commercial transactions. VisaNet™, in particular, includes an integrated payments system that processes authorization requests and a Base II system that performs clearing and settlement services. The processing network 116 may use any suitable wired or wireless network, including the Internet.

An authentication computer 114 is typically associated with a business entity (e.g., a bank). The authentication computer 114 may comprise a server computer. The server computer may include a processor and a computer readable medium coupled to the processor, the computer readable medium comprising code, executable by the processor. In some embodiments, the authentication computer 114 may communicate with the processing network 116 to provide authentication processes and account information associated with an account of the user 102. The authentication computer 114 may maintain financial accounts for the user 102, and may be associated with issuing payment devices, such as a credit or debit card to the user 102. The components 104, 110, 114, and 116 may all be in operative communication with each other through any suitable communication channel or communications network. Suitable communications networks may be any one and/or the combination of the following: a direct interconnection; the Internet; a Local Area Network (LAN); a Metropolitan Area Network (MAN); and Operating Missions as Nodes on the Internet (OMNI); a secured customer connection; a Wide Area Network (WAN); a wireless network (e.g., employing protocols such as, but not limited to a Wireless Application Protocol (WAP), I-mode, and/or the like); and/or the like.

Messages between the computers, networks, and devices may be transmitted using secure communications protocols such as, but not limited to, File Transfer Protocol (FTP); HyperText Transfer Protocol (HTTP); Secure Hypertext Transfer Protocol (HTTPS); Secure Socket Layer (SSL); ISO (e.g., ISO 8583) and/or the like.

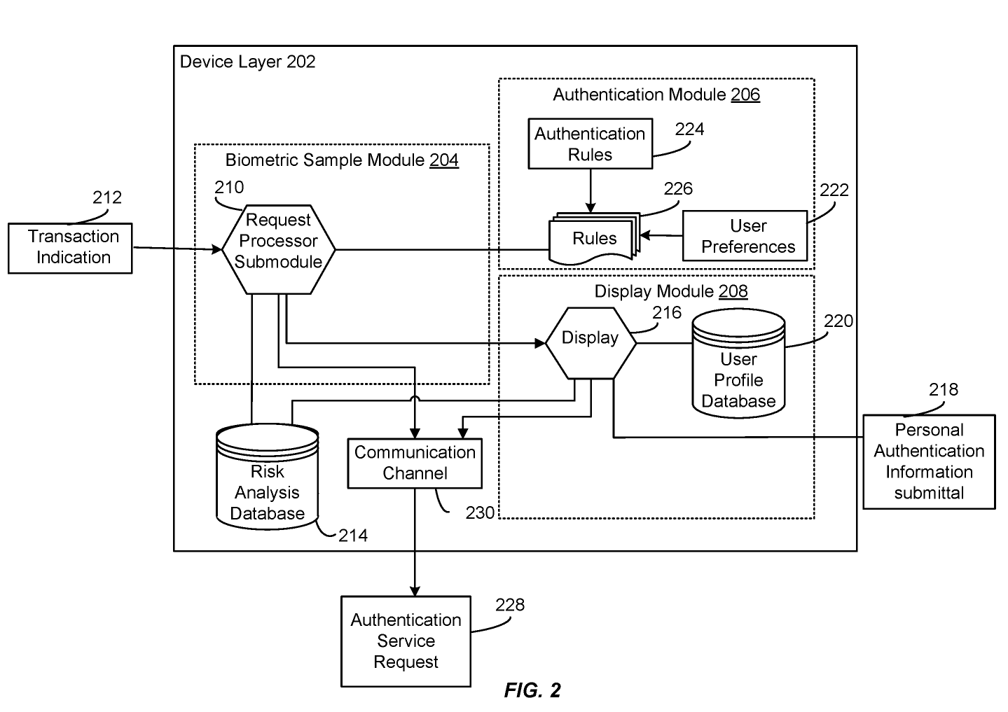

FIG. 2 depicts a block diagram of a system and a process flow according to embodiments of the current disclosure. In FIG. 2, device layer 202 is depicted as being an example device layer for virtual reality hardware (such as virtual reality hardware 104). The device layer 202 may include a biometric sample module 204, an authentication module 206, and a display module 208. As used herein, a “module” may include a software module, a hardware module, or any suitable combination of software and hardware to implement the techniques described herein. In some embodiments, the biometric sample module 204 may be programmed to cause the virtual reality hardware to obtain a biometric sample and prompt an avatar of the user in the virtual reality environment for personal authentication information. In the biometric sample module 204, a request processor submodule 210 may receive a transaction indication 212 from an avatar of the user who initiates a transaction in a virtual reality environment. In some embodiments, the request processor submodule 210 may have access to a risk analysis database 214. The risk analysis database 214 may be configured to maintain a plurality of generated values that represent a risk associated with previously conducted transactions. In embodiments, the risk analysis database 214 may maintain the values for each user associated with the authentication service and may identify trends associated with individual users or with particular resource providers. An aggregate value may be generated by the authentication module 206 using the information maintained in the risk analysis database 214 for use in determining whether to authenticate a transaction.

In some embodiments, the request processor submodule 210 may be configured to generate a partial biometric template for use by the authentication module 206 to authenticate the transaction. The request processor submodule 210 may communicate the partial biometric template to the authentication module 206. In some embodiments, the display module 208 may be configured to prompt the user in the virtual reality environment for personal authentication information. The prompt may be provided by the display 216. The display 216 may receive the personal authentication information submittal 218 that an avatar of the user provided within the virtual reality environment. In some embodiments, the display module 208 may maintain previously submitted personal authentication information from a user's avatar in user profile database 220. This information may be used by the authentication module 206 to authenticate a transaction on behalf of the user.

In some embodiments, the authentication module 206 may utilize user preferences 222 and authentication rules 224 to generate rules 226 for use in authenticating a transaction. For example, the user preferences 222 may require the use of certain thresholds when determining whether to authenticate a transaction (for use in the risk value vs. threshold comparison described herein). In some embodiments, the authentication rules 224 may include rules provided by resource providers or set by the authentication service itself. For example, the authentication rules 224 may indicate that another and different biometric sample must be obtained from the user for use in determining whether to authenticate the transaction. In some embodiments, the biometric sample module 204 may generate incomplete sets of eigenvalues from the biometric sample(s) which can then be utilized by the authentication module 206 to authenticate the transaction. It should be noted that although FIG. 2 depicts an authentication module 206 included in the virtual reality hardware that can be utilized to authenticate transactions, in some embodiments the authentication processes described herein may be enabled and performed by the authentication computer 114 and either combination of devices, computers, and/or modules may perform the processes described herein. For example, certain portions of the process (such as obtaining the biometric sample and generation a partial biometric template) may be performed by the virtual reality hardware while other portions of the process (such as authentication) may be performed by the authentication computer 114.

In some embodiments, the user profile database 220 may be configured to maintain information about the user including an address and telephone number for the user, and explicit preferences provided by the user during an enrollment process. For example, a user may specify during an enrollment process that they do not wish to receive offers or recommendations from resource providers via the virtual reality hardware. In some embodiments, the request processor submodule 210 may make an authentication service request 228 via the communication channel 230. The authentication service request 228 can be a request for fund checking and clearing and settlement services from a processing network (such as processing network 116). In embodiments, the request processor submodule 210 can process multiple authentication service requests 228 on behalf of the user conducting several transactions with a plurality of resource providers in the virtual reality environment.

In some embodiments, the device layer 202 for the virtual reality hardware may exclude the authentication module 206 and components 222, 224, and 226. In such embodiments, the virtual reality hardware may be configured to obtain the biometric sample and the personal authentication information, generate partial biometric templates or eigenvalues, and provide an authentication service request 228 to an authentication entity (such as authentication computer 114) for authenticating the transaction. The device layer 202 may provide the partial biometric template, incomplete set of eigenvalues, and the personal authentication information via the communication channel 230. The authentication computer 114 may be configured to maintain and utilize the authentication rules 224, user preferences 222, risk analysis database 214, and user profile database 220 in authenticating the transaction. In some embodiments, the display module 208 and display 216 may be configured to generate and present a transaction code in the virtual reality environment that the avatar of the user can utilize to complete the transaction. For example, the display 216 may present a QR code that the avatar of the user can utilize to interact with a representation of an POS device in the virtual reality environment and complete the transaction.

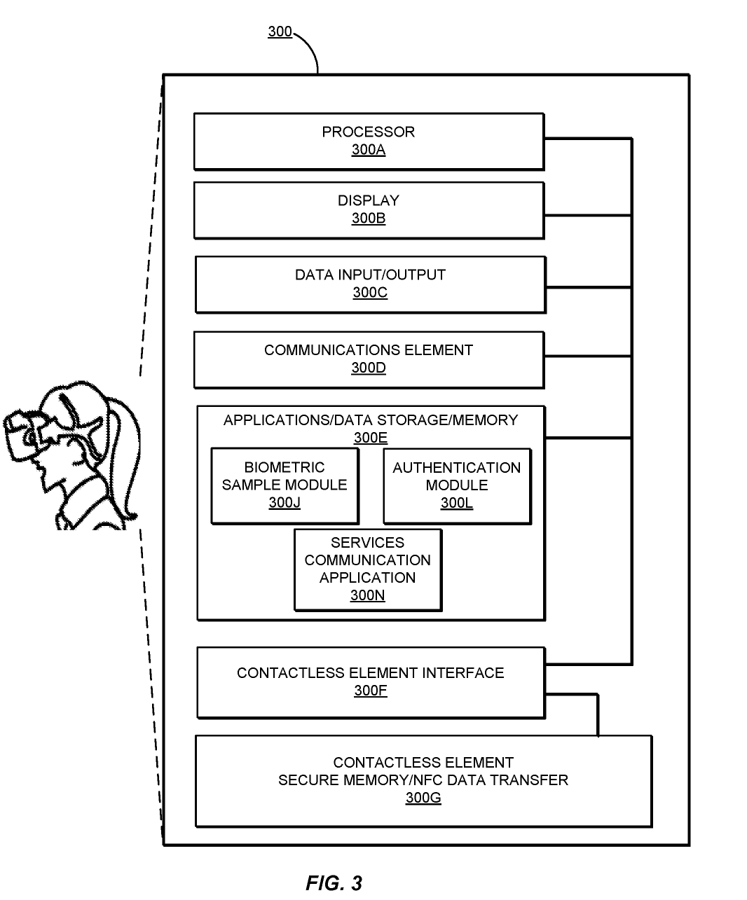

An example of virtual reality hardware implementing the device layer 202, according to some embodiments of the invention, is shown in FIG. 3. Virtual reality hardware 300 may include circuitry that is used to enable certain device functions, such as presentation of a virtual reality environment, receiving and processing input provided by the avatar of the user in the virtual reality environment, and receiving and processing information and input provided by the user in the real world (such as gestures). The functional elements responsible for enabling those functions may include a processor 300A that can execute instructions that implement the functions and operations of the device. Processor 300A may access memory 300E (or another suitable data storage region or element) to retrieve instructions or data used in executing the instructions, such as provisioning scripts and applications. Data input/output elements 300C, such as a hand held device, joystick, haptic sensors, motion sensors, or other haptic input devices, may be used to enable a user to operate the virtual reality hardware 300 and input data (e.g., confirmation of purchase, initiate a transaction, or provide personal authentication information via the virtual reality environment).

Data input/output elements 300C may also be configured to output data (via a lens, headset, or other suitable hardware associated with virtual reality hardware 300). Display 300B may also be used to output data to a user. Communications element 300D may be used to enable data transfer between virtual reality hardware and other entities associated with providing assets of the virtual reality environment, a processing network, resource provider computers, or an authentication computer via a wired or wireless network, and enabling data transfer functions (such as providing access credentials for completing a transaction). Virtual reality hardware 300 may also include contactless element interface 300F to enable data transfer between contactless element 300G and other elements of the virtual reality hardware 300, where contactless element 300G may include a secure memory and a near field communications data transfer element (or another form of short range communications technology).

The memory 300E may comprise a biometric sample module 300J, an authentication module 300L, services communication application 300N, and any other suitable module or data. The virtual reality hardware 300 may have any number of applications or modules installed or stored on the memory 300E and is not limited to that shown in FIG. 3. The memory 300E may also comprise code, executable by the processor 300A for implementing methods described herein.

The biometric sample module 300J may, in conjunction with the processor 300A, may obtain one or more biometric samples of a user in response to an indication that an avatar of a user has initiated a transaction in a virtual reality environment presented by the virtual reality hardware 300. The biometric sample module 300J and services communication application 300N, and the processor 300A, may be configured to communicate with one or more outside services or entities including resource provider computers, an authentication computer, a processing network, or other suitable entity for authenticating the transaction as described herein. In some embodiments, the biometric sample module 300J and services communication application 300N, in conjunction with the processor 300A, may be configured to prompt the avatar of the user for personal authentication information that can be used to further encrypt a partial biometric template. In some embodiments, the biometric sample module 300J in conjunction with the processor 300A and the services communication application 300 N, may generate a partial biometric template from the biometric sample and communicate the personal authentication information and the partial biometric template to an authentication computer for authenticating the transaction as described herein.

In some embodiments, the authentication module 300L may, in conjunction with the processor 300A, be configured to utilize the partial biometric template and personal authentication information to authenticate the transaction according to methods described herein. In embodiments, the authentication module 300L and services communication application 300N may, in conjunction with the processor 300A, be configured to communicate with the processing network as part of an authorization request message prior to providing an access credential to a resource provider computer. In some embodiments, in order to increase security, access credentials may not be stored at the virtual reality hardware 300. Instead, the access credentials can be temporarily retrieved from a remote server or cloud server when a transaction is being performed. In some embodiments, the authentication module 300L may store and utilize one or more private-public key pairs to sign authorization requests for authorization by a processing network that issued or maintains the private-public key pairs. In some embodiments, the authentication module 300L merely requests authentication, via the processor 300A and the services communication application 300N, from an authentication computer and communicates the generated partial biometric template and personal authentication information. In some embodiments, the biometric sample module 300J, in conjunction with processor 300A, may be configured to generate an incomplete eigenvalue set from the biometric sample that represents a partial biometric template. The incomplete eigenvalue set can be salted using the personal authentication information and provided to the authentication module 300L for authentication or to an authentication computer for authenticating the transaction.

In some embodiments, the authentication module 300L may be issued a token from a processing network via the communications element 300D. The token can be used in place of or represent the access credential and add an additional layer of security to the sensitive payment account information of the user. In some embodiments, the authentication module 300L may be programmed to cause the virtual reality hardware 300 to send a token request message to a processing network via communication channels typically used for authorization request messages. In some embodiments, the authentication module 300L, in conjunction with the processor 300A, may be configured to generate and present a transaction token to the avatar of the user in the virtual reality environment for use in completing the transaction. For example, the avatar of the user may utilize a provided QR code to interact with a representation of a POS device in the virtual reality environment that is associated with a resource provider to complete the transaction. Upon presenting the QR code, communications between the processing network and the resource provider computer may occur which debit and credit the appropriate accounts based on a type of transaction.

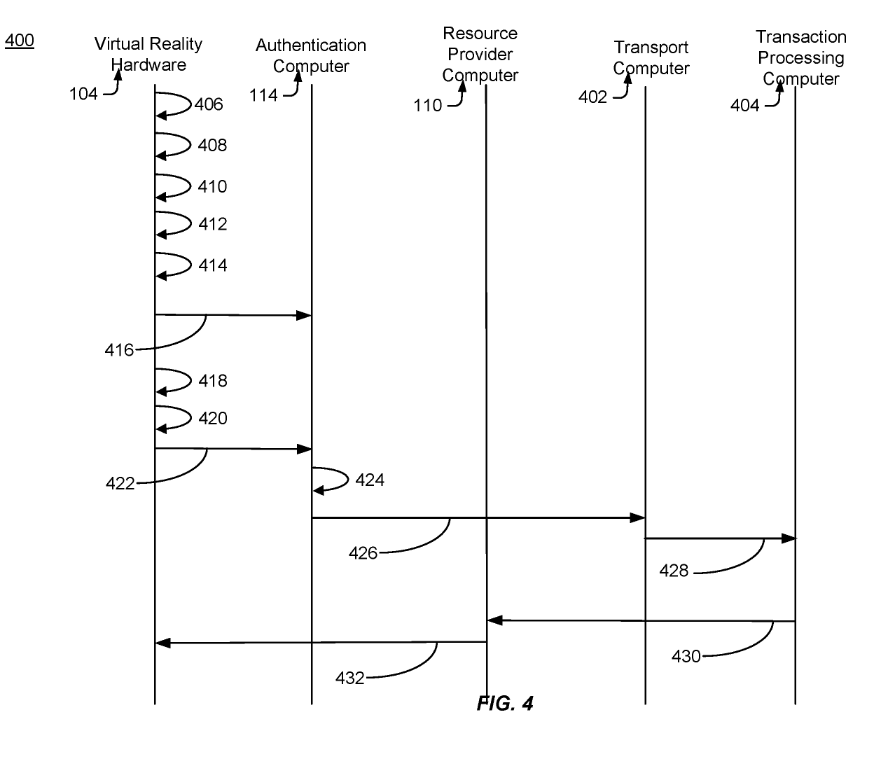

FIG. 4 depicts a diagram illustrating an example technique for completing a transaction via virtual reality hardware according to embodiments of the current disclosure. The order in which the operations are described is not intended to be construed as a limitation, and any number of the described operations can be omitted or combined in any order and/or in parallel to implement this process and any other processes described herein.

Some or all of the process 400 (or any other processes described herein, or variations and/or combinations thereof) may be performed under the control of one or more computer systems configured with executable instructions and may be implemented as code (e.g., executable instructions, one or more computer programs, or one or more applications). In accordance with at least one embodiment, the process 400 of FIG. 4 may be performed by at least the one or more computer systems including virtual reality hardware 104, processing network 116 (FIG. 1), resource provider computer 110, or authentication computer 114. FIG. 4 also includes a transport computer 402 and transaction processing computer 404. The code may be stored on a computer-readable storage medium, for example, in the form of a computer program including a plurality of instructions executable by one or more processors. The computer-readable storage medium may be non-transitory. The virtual reality hardware, authentication computer, resource provider computer, transport computer, and transaction processing computer may all be in operative communication with each other through any suitable communication channel or communications network. Suitable communications networks may be any one and/or the combination of the following: a direct interconnection; the Internet; a Local Area Network (LAN); a Metropolitan Area Network (MAN); an Operating Missions as Nodes on the Internet (OMNI); a secured custom connection; a Wide Area Network (WAN); a wireless network (e.g., employing protocols such as, but not limited to a Wireless Application Protocol (WAP), I-mode, and/or the like); and/or the like.

Messages between the computers, networks, and devices may be transmitted using a secure communications protocols such as, but not limited to, File Transfer Protocol (FTP); HyperText Transfer Protocol (HTTP); Secure Hypertext Transfer Protocol (HTTPS), Secure Socket Layer (SSL), ISO (e.g., ISO 8583) and/or the like.

The process 400 may include receiving an indication of receiving an indication of a transaction initiated by an avatar of a user in a virtual reality environment at 406. The virtual reality environment may be presented by the virtual reality hardware. In some embodiments, the virtual reality hardware may receive an indication of a transaction conducted by an avatar of the user in the virtual reality environment indicating that the user seeks to purchase a ticket for a movie. In some embodiments, the process 400 may include obtaining, by the virtual reality hardware, a first biometric sample from the user interacting with the virtual reality hardware at 408. In some embodiments, the process 400 may include requesting and receiving personal authentication that is provided by the avatar of the user within the virtual reality environment at 410. In embodiments, the process 400 may include generating a first incomplete set of eigenvalues utilizing the first biometric sample at 412. The process 400 may include salting the first incomplete set of eigenvalues using the personal authentication information at 414. In some embodiments, the first incomplete set of eigenvalues may represent a partial biometric template.

The process 400 may include providing the salted first incomplete set of eigenvalues to the authentication computer at 416. In some embodiments, the process 400 may include obtaining a second biometric sample from the user interacting with the virtual reality hardware at 418. The second biometric sample may be different from the first biometric sample. For example, if the first biometric sample is a facial image, the second biometric sample may be a fingerprint. The process 400 may include generating a second incomplete set of eigenvalues using the second biometric sample at 420. In some embodiments, the process 400 may include providing the second incomplete set of eigenvalues to the authentication computer at 422. In some embodiments, the process may include authenticating the transaction, by the authentication computer, utilizing the first incomplete set of eigenvalues and the second incomplete set of eigenvalues at 424. For example, the authentication computer may utilize a machine learning algorithm to cluster the two sets of partial data to determine the authentication of the user conducting the transaction. In embodiments, the partial data may include incomplete and/or partial sets of eigenvalues. In embodiments, the machine learning algorithm may be a deep learning or supervised learning machine learning algorithm that is trained utilizing partial biometric templates as described herein. For example, morphed, transformed and/or salted samples may be provided as input to the machine learning algorithm to generate risk scores which are then compared to particular thresholds. Based on the results of the comparison the machine learning algorithm can be adjusted to properly interpret new samples submitted that are either in a salted, encrypted, or plain state. The machine learning model can be repeatedly tested and fed new input until the model can predict the authenticity of a sample within a certain percentage of accuracy. In embodiments, the machine learning models variables can be adjusted by utilizing Stochastic Gradient Descent, Hill Climbing, or any suitable optimization approach for training machine learning algorithms/models.

The process 400 may include the authentication computer requesting that the transaction be authorized (check available funds are available) by providing an authentication request message to the transport computer 402 (which may be an acquirer computer) at 426. The transport computer may be associated with the authentication computer or resource provider computer, and may manage authorization requests on behalf of either computer.

FIG. 4 also includes a transaction processing computer 404 which may be disposed between the transport computer 402 and an issuer computer (not shown). The transaction processing computer 404 may include data processing subsystems, networks, and operations used to support and deliver authorization services, exception file services, and clearing and settlement services. For example, the transaction processing computer 404 may comprise a server coupled to a network interface (e.g., by an external communication interface), and databases of information. The process 400 may include the transport computer 402 requesting authorization of the transaction via the transaction processing computer 404 at 428. The process 400 may include the transaction processing computer 404 providing an authorization response message to the resource provider computer 110 at 430. In some embodiments, the resource provider computer 110 may proceed with completing the transaction upon receiving the authorization response message. In embodiments, the transaction processing computer 404 may provide the authorization response message directly to the virtual reality hardware 104 to enable the virtual reality hardware 104 to transmit an access credential to resource provider computer 110 to complete the transaction. A clearing and settlement process can occur at the end of the day or at any other suitable time period. In some embodiments, the process 400 may include the resource provider computer 110 providing a prompt or request to the virtual reality hardware 104 that queries the avatar of the user within the virtual reality environment to confirm the transaction at 432 in response to receiving the authorization response message.

In some embodiments, the issuer computer may issue and manage a payment account and an associated payment device of a user. The issuer computer may be able authorize transactions that involve the payment account. Before authorizing a transaction, the issuer computer may authenticate payment credentials received in the authorization request, and check that there is available credit or funds in an associated payment account. The issuer computer may also receive and/or determine a risk level associated with the transaction, and may weigh the risk when deciding whether or not to authorize the transaction. If the issuer computer receives an authorization request that includes a payment token, the issuer computer may be able to de-tokenize the payment token in order to obtain the associated payment credentials.

Embodiments of the invention have a number of advantages. As noted above, by using a partial biometric template as an authentication factor in the virtual reality environment, some authentication data based upon the user can be used by the user's actual biometric data is protected since the user's complete biometric data is not exposed in the virtual reality environment. Other security benefits may be gained by embodiments of the invention. For example, by prompting a user's avatar for personal authentication information and obtaining a biometric sample, a multi-step authentication process can be enabled. As such, if a user's avatar is compromised, the lack of the user's biometric sample will prevent the transaction from being authorized. To continue the example, if the user's biometric data is somehow captured by a fraudster, the fraudster may still be prevented from completing the transaction as they would need to know the personal authentication information and provide it within the virtual reality environment as an avatar of the user.

As described herein, a computer system may be used to implement any of the entities or components described above. The subsystems of a computer system may be interconnected via a system bus. Additional subsystems such as a printer, keyboard, fixed disk (or other memory comprising computer readable media), monitor, which is coupled to display adapter, and others are also included in embodiments described herein. Peripherals and input/output (I/O) devices, which may be coupled to an I/O controller (which can be a processor or other suitable controller), can be connected to the computer system by any number of means known in the art, such as a serial port. For example, a serial port or external interface can be used to connect the computer apparatus to a wide area network such as the Internet, a mouse input device, or a scanner. The interconnection via system bus allows the central processor to communicate with each subsystem and to control the execution of instructions from system memory or the fixed disk, as well as the exchange of information between subsystems. The system memory and/or the fixed disk of the computer system may embody a computer readable medium. In some embodiments, the monitor may be a touch sensitive display screen.

A computer system can include a plurality of the same components or subsystems, e.g., connected together by an external interface or by an internal interface. In some embodiments, computer systems, subsystem, or apparatuses can communicate over a network. In such instances, one computer can be considered a client and another computer a server, where each can be part of a same computer system. A client and a server can each include multiple systems, subsystems, or components.

It should be understood that any of the embodiments of the present invention can be implemented in the form of control logic using hardware (e.g. an application specific integrated circuit or field programmable gate array) and/or using computer software with a generally programmable processor in a modular or integrated manner. As used herein, a processor includes a single-core processor, multi-core processor on a same integrated chip, or multiple processing units on a single circuit board or networked. Based on the disclosure and teachings provided herein, a person of ordinary skill in the art will know and appreciate other ways and/or methods to implement embodiments of the present invention using hardware and a combination of hardware and software.

Any of the software components or functions described in this application may be implemented as software code to be executed by a processor using any suitable computer language such as, for example, Java, C, C++, C#, Objective-C, Swift, or scripting language such as Perl or Python using, for example, conventional or object-oriented techniques. The software code may be stored as a series of instructions or commands on a computer readable medium for storage and/or transmission, suitable media include random access memory (RAM), a read only memory (ROM), a magnetic medium such as a hard-drive or a floppy disk, or an optical medium such as a compact disk (CD) or DVD (digital versatile disk), flash memory, and the like. The computer readable medium may be any combination of such storage or transmission devices.

Such programs may also be encoded and transmitted using carrier signals adapted for transmission via wired, optical, and/or wireless networks conforming to a variety of protocols, including the Internet. As such, a computer readable medium according to an embodiment of the present invention may be created using a data signal encoded with such programs. Computer readable media encoded with the program code may be packaged with a compatible device or provided separately from other devices (e.g., via Internet download). Any such computer readable medium may reside on or within a single computer product (e.g. a hard drive, a CD, or an entire computer system), and may be present on or within different computer products within a system or network. A computer system may include a monitor, printer, or other suitable display for providing any of the results mentioned herein to a user.

The above description is illustrative and is not restrictive. Many variations of the invention will become apparent to those skilled in the art upon review of the disclosure. The scope of the invention should, therefore, be determined not with reference to the above description, but instead should be determined with reference to the pending claims along with their full scope or equivalents.

One or more features from any embodiment may be combined with one or more features of any other embodiment without departing from the scope of the invention.

A recitation of “a”, “an” or “the” is intended to mean “one or more” unless specifically indicated to the contrary.

All patents, patent applications, publications, and descriptions mentioned above are herein incorporated by reference in their entirety for all purposes. None is admitted to be prior art.

What is claimed is:

1. A computer-implemented method, comprising:
receiving, by a processor associated with virtual reality hardware, an indication that an avatar of a user has initiated a transaction in a virtual reality environment, the virtual reality environment presented by the virtual reality hardware to the user;
obtaining, by the processor, a first biometric sample from the user interacting with the virtual reality hardware;
generating, by the processor, a partial biometric template based at least in part on the first biometric sample; and
providing, by the processor, the partial biometric template and personal authentication information for the avatar to an authentication computer, wherein the personal authentication information and the partial biometric template are used to authenticate the avatar.

2. The computer-implemented method of claim 1, further comprising:
obtaining, by the processor, a second biometric sample from the user via an associated computer device other than the virtual reality hardware; and
receiving an authentication response message, from the authentication computer, that is based in part on a machine learning algorithm comparing a risk score generated using the partial biometric template and the second biometric sample to a threshold.

3. The computer-implemented method of claim 2, wherein the authentication response message is provided to a resource provider associated with the transaction.

4. The computer-implemented method of claim 3, further comprising providing a transaction code to the avatar of the user to complete the transaction in response to providing the authentication response message to the resource provider.

5. The computer-implemented method of claim 1, wherein receiving the indication that the avatar of the user has initiated the transaction in the virtual reality environment includes presentation by the avatar of a unique identifier to a resource provider in the virtual reality environment.

6. The computer-implemented method of claim 5, wherein the unique identifier includes a barcode or a representation of an access device in the virtual reality environment.

7. Virtual reality hardware comprising:
a processor; and
a memory including instructions that, when executed with the processor, cause the virtual reality hardware to, at least:
receive an indication that an avatar of a user has initiated a transaction in a virtual reality environment, the virtual reality environment presented by the virtual reality hardware to the user;
obtain a first biometric sample from the user interacting with the virtual reality hardware;
generate a partial biometric template based at least in part on the first biometric sample; and
provide the partial biometric template and personal authentication information for the avatar to an authentication computer, wherein the personal authentication information and the partial biometric template are used to authenticate the avatar.

8. The virtual reality hardware of claim 7, wherein the personal authentication information includes one or more of a password, an answer to a security question, or a unique alpha-numeric string.

9. The virtual reality hardware of claim 7, wherein the instructions, when executed with the processor further cause the virtual reality hardware to present a prompt in the virtual reality environment to confirm the transaction.

10. The virtual reality hardware of claim 7, wherein the transaction is associated with access to secure data or a secure area of a resource provider.

11. The virtual reality hardware of claim 7, wherein the instructions, when executed with the processor further cause the virtual reality hardware to:
generate a first incomplete set of eigenvalues based in part on the first biometric sample;
salt the first incomplete set of eigenvalues using the personal authentication information; and
provide the salted first incomplete set of eigenvalues to the authentication computer that is used to authenticate the avatar.

12. The virtual reality hardware of claim 11, wherein generating the first incomplete set of eigenvalues includes using a particular number of characteristics of a set of eigenvalues based in part on a type of the transaction.

13. The virtual reality hardware of claim 7, wherein the personal authentication information is provided by the user prior to initiating the transaction in the virtual reality environment.

14. The virtual reality hardware of claim 7, wherein the first biometric sample is obtained from the user in response to receiving the indication that the avatar of the user has initiated the transaction in the virtual reality environment.

15. A computer-implemented method, comprising:
receiving, by an authentication computer, a first biometric sample and personal authentication information associated with a user initiating a transaction in a virtual reality environment, the personal authentication information provided by an avatar of the user in the virtual reality environment;
generating, by the authentication computer, a partial biometric template based at least in part on the first biometric sample;
generating, by the authentication computer, a value based at least in part on the partial biometric template and the personal authentication information, the value representing a risk level associated with the transaction; and
authenticating, by the authentication computer, the transaction based at least in part on the value and a threshold associated with the transaction.

16. The computer-implemented method of claim 15, further comprising providing an authentication response message to a resource provider computer associated with the transaction.

17. The computer-implemented method of claim 15, further comprising:
receiving, by the authentication computer, a second biometric sample of the user, the second biometric sample being different than the first biometric sample; and
generating, by the authentication computer, a first incomplete set of eigenvalues based in part on the first biometric sample, and a second incomplete set of eigenvalues based in part on the second biometric sample, wherein authenticating the transaction is further based at least in part on comparing a profile generated from the first incomplete set of eigenvalues and the second incomplete set of eigenvalues to an aggregate profile associated with the transaction.

18. The computer-implemented method of claim 17, wherein the value is generated further based in part on a machine learning algorithm using the first incomplete set of eigenvalues and the second incomplete set of eigenvalues.

19. The computer-implemented method of claim 15, further comprising providing a transaction code to the avatar of the user in the virtual reality environment enabling the user to complete the transaction.

20. The computer-implemented method of claim 15, further comprising presenting a prompt to the avatar of the user in the virtual reality environment to confirm the transaction.
